(19) United States
(12) Patent Application Publication
(10) Pub. No.: US 2024/0104391 A1
(43) Pub. Date: Mar. 28, 2024

(54) REWARD-MODEL BASED REINFORCEMENT LEARNING FOR PERFORMING REASONING TASKS

(71) Applicant: DeepMind Technologies Limited, London (GB)

(72) Inventors: Irina Higgins, London (GB); Jonathan Ken Uesato, London (GB); Nathaniel Arthur Kushman, Cambridge (GB); Ramana Kumar, London (GB)

(21) Appl. No.: 18/475,743

(22) Filed: Sep. 27, 2023

Related U.S. Application Data
(60) Provisional application No. 63/377,532, filed on Sep. 28, 2022.

(51) Int. Cl. G06N 3/092

(52) U.S. Cl. CPC G06N 3/092

(57) ABSTRACT

Methods, systems, and apparatus, including computer programs encoded on computer storage media, for A training a language model for performing a reasoning task. The system obtains a plurality of training examples. Each training example includes a respective sample query text sequence characterizing a respective sample query and a respective reference response text sequence that includes a reference final answer to the respective sample query. The system trains a reward model on the plurality of training examples. The reward model is configured to receive an input including a query text sequence characterizing a query and one or more reasoning steps that have been generated in response to the query and process the input to compute a reward score indicating how successful the one or more reasoning steps are in yielding a correct final answer to the query. The system trains the language model using the trained reward model.

### CROSS-REFERENCE TO RELATED APPLICATION

This application claims priority to U.S. Provisional Patent Application No. 63/377,532, filed on Sep. 28, 2022, the disclosure of which is hereby incorporated by reference in its entirety.

### BACKGROUND

This specification relates to performing reasoning tasks using a machine-learning model, such as a neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

The parameters of a machine learning model can be determined through a training process based on training data that includes one or more training examples. For example, neural networks can be trained by updating the network parameters, including, e.g., weights and bias coefficients of the network layers of the neural network.

### SUMMARY

This specification describes methods, computer systems, and apparatus, including computer programs encoded on computer storage media, for performing a reasoning task using a language model. In particular, the reasoning task includes providing a response to an input query. More specifically, the response may include (1) a final answer to the query and (2) a reasoning trace including a sequence of one or more reasoning steps to yield the final answer to the query.

Language model and language generation neural networks can perform a variety of tasks, such as translation tasks (provided that the training corpus included words in different languages), and arithmetic tasks, among many other tasks. Relevant to reasoning tasks, a language model can be used to generate a response to a query (e.g., a question). The response to the query can be provided as a text sequence, for example, in the form of a yes/no binary answer, an answer providing one or more numerical values, an answer identifying one or more objects or events, an answer identifying planned routes or actions, and so on. The response to the query may be used by a human or a computer system in many ways. For example, the answer and the reasoning trace may be useful in itself, or it may be used to provide a warning and/or to control the motions of one or more robotic agents or objects, e.g. an autonomous vehicle.

In some implementations, the input query can be a natural language query relating to an environment, in particular a real-world environment. The output response can be a natural language reply or natural language output statement that also relates to the environment. For example, the output response can provide information relating to the environment, in some implementations, information relating to or specifying actions to be taken in the environment.

In one example, the system can be used for diagnosing a fault in a mechanical system operating in the real-world environment. The input query can include observations about the mechanical system, e.g., from one or more sensors (e.g. cameras, microphones, accelerometers, temperature sensors, and so on), and a question about the mechanical system. In some implementations, the observations may include sensed electronic signals such as motor current or a temperature signal; and/or image or video data for example from a camera or a LIDAR sensor, e.g., data from sensors of a mechanical agent or data from sensors that are located separately from the mechanical agent in the environment. The observations and the question can be proposed to generate a language representation of the query. For example, the query may comprise a general question such as “Given the measurements from sensors A, B, and C, is the system working correctly?” or “Given the measurements of A, B, and C, what is wrong with the system?” or a specific request such as “Is there a fault with component X?” The output response can provide a final answer to the question and a reasoning trace leading to the final answer.

In another example, the environment can be an educational environment, e.g., the system can be deployed as part of an educational software program that assists a user in learning or practicing one or more corresponding skills. For example, the input query can be a math word problem, and the output response includes the correct solution to the word problem and intermediate steps for reaching the correct solution. The output response can be provided to a student as a demonstration of how to solve the math problem, or be used as a grading tool to provide feedback on the student's practice.

In another example, the system can be used for natural language control of a task in a real-world environment. That is, the input query can relate to the task, e.g. it may comprise a request to perform the task. The output response may be used to control e.g. a mechanical system (which may be referred to as a mechanical agent), or a computer system for performing the task. As one example, the input query can include a high-level question, e.g. from a human, to perform a task, e.g., “What is the most cost-effective way to fabricate this component with our current equipment?” (the real-world environment may be a manufacturing facility in such cases). The output response includes a final answer specifying a planned procedure, and the reasoning steps for determining the planned procedure. The output response can be used to control one or more mechanical agents, e.g., robotic arms, to perform the planned procedure. For example, the output response may comprise one or more control signals for controlling the one or more mechanical agents, such as position, velocity, or force/torque/acceleration data for one or more joints of a robot or parts of another mechanical agent. In some implementations, the input query can relate to a real-world task and can specify observations of the real-world environment, and the output response can specify actions or routes to be taken in the real-world environment by a user to perform the task. The system can provide the output response to the user, e.g., via a display or an audio output device, to guide the user to perform the task in the real-world environment. Output responses generated using the methods described in this specification can greatly improve the utility and safety with which mechanical agents, computer systems, or human users can perform real-world tasks in real-world environments, particularly for tasks for which generating inaccurate responses can have significant negative consequences. In particular, the output responses may be used to perform the task in a principled and logical manner.

In some implementations, the reasoning trace in the output response provides a human-interpretable explanation that can be used, e.g., by a user to 1) determine whether to perform the actions specified in the final answer in the output response or 2) later accessed when certain criteria are satisfied to evaluate the performance of the language model or to diagnose causes for errors occurring as a consequence of performing the actions specified in the responses generated by the language model. The human-interpretable explanation may, for example, comprise a sequence of logical steps, presented as natural language statements, that lead from the query to the response in a causal chain. Such human-interpretable explanations may overcome or mitigate some of the disadvantages of otherwise using language models (particularly neural network-based language models) as a “black box”, by allowing human users to understand the reasons behind a response provided by the language model.

In one particular aspect, this specification describes a system implemented as computer programs on one or more computers in one or more locations that trains a language model for performing a reasoning task.

The system includes a reward model configured to receive an input including a query text sequence characterizing a query and one or more reasoning steps that have been generated in response to the query and process the input to compute a score indicating how successful the one or more reasoning steps are in yielding a correct final answer to the query.

The system can train the reward model using outcome-supervised training or process-supervised training using a plurality of training examples. In general, each training example includes a respective sample query text sequence characterizing a respective sample query (i.e. training query) and a respective reference response text sequence that comprises a reference (“ground truth”) final answer to the respective sample query. For each training example, the system can generate one or more candidate reasoning traces in response to the sample query of the training example. Each candidate reasoning trace includes one or more reasoning steps. The system can assign a target score for each reasoning step in each candidate reasoning trace based on the reference response text sequence in the training example, where the target score indicates whether the reasoning step is correct or incorrect. The system then trains the reward model to generate reward scores for the reasoning steps in the candidate reasoning traces that match the corresponding target scores for the reasoning step.

In outcome-supervised training, the system determines whether the candidate reasoning trace yields the reference final answer in the training example. If the candidate reasoning trace yields the reference final answer in the training example, the system assigns to each reasoning step in the candidate reasoning trace a reward score indicating that the reasoning step is correct. If the candidate reasoning trace does not yield the final answer in the training example, the system assigns to each reasoning step in the candidate reasoning trace a reward score indicating that the reasoning step is incorrect.

In process-supervised training, the reference response text sequence includes a reference reasoning trace including a sequence of reasoning steps that include the final answer as the last reasoning step. The system assigns the target score for a current reasoning step based on whether the reasoning steps that have been generated up to the current reasoning step match a sequence of reasoning steps in the reference reasoning trace. That is, the target score for a current reasoning step may be determined based on comparisons (e.g. similarity score) between each of the reasoning steps that have been generated up to (and including) the current reasoning step and corresponding reasoning steps in the sequence of reasoning steps in the reference reasoning trace.

To train the language model, the system can receive a training query, and use a policy language model and the trained reward model to generate one or more expert reasoning traces in response to the training query, where each respective expert reasoning trace includes a respective plurality of reasoning steps. The system can use the one or more expert reasoning traces to train the language model. The policy language model can be a model configured to receive an input including a query text sequence characterizing a query and one or more reasoning steps that have been generated in response to the query, and process the input to generate a next reasoning step.

In some implementations, to generate the expert traces, the system uses the policy language model to generate a plurality of candidate expert reasoning traces in response to the training query. The system can use the reward model to generate a performance score for each of the candidate expert reasoning traces based on the reward scores generated for the reasoning steps in the candidate expert reasoning trace. The system selects one or more candidate expert reasoning traces having the highest performance scores as the expert reasoning traces.

In some implementations, to generate the expert traces, after one or more reasoning steps having been generated for the expert reasoning trace, the system uses the policy language model to generate a plurality of candidate next reasoning steps. The system uses the reward model to generate a reward score for each of the candidate next reasoning steps, and selects the candidate next reasoning step with the highest reward score as the next step for the expert reasoning trace. The system can repeat the above steps until the next step matches a final answer indicator (e.g. until the next reasoning step comprises text corresponding to the final answer) or a maximum number of steps have been reached. The system can then use the resulting reasoning trace as the expert reasoning trace.

In another aspect, this specification describes a system implemented as computer programs on one or more computers in one or more locations that performs a reasoning task using a language model.

The system can obtain an input text sequence characterizing an input query. The system further obtains a reward model that has been trained on a plurality of training examples, wherein each training example includes a respective sample query text sequence characterizing a sample query and a respective reference response text sequence, wherein the reference response text sequence includes at least a reference final answer to the sample query, and wherein the reward model is configured to process an input including a query text sequence characterizing a query and one or more reasoning steps that have been generated in response to the query, to compute a reward score indicating how successful the one or more reasoning steps are for yielding a correct final answer to the query.

The system uses the language model to generate a plurality of candidate reasoning traces as responses to the input query. Each candidate reasoning trace includes a respective plurality of candidate reasoning steps that include a candidate final answer. The system can select, based on one or more reward scores computed by the trained reward model, the best reasoning trace from the plurality of candidate reasoning traces, and outputs the best reasoning trace as an output response to the input query.

This specification also describes computer-implemented methods performed by the systems described above. This specification further describes one or more computer storage media storing instructions that when executed by one or more computers, cause the one or more computers to perform the methods described above.

The subject matter described in this specification can be implemented in particular implementations so as to realize one or more of the following advantages.

This specification provides techniques for using a reward model to guide the reinforcement learning of a language model to perform a reasoning task. Although the reward model can be trained and applied either using purely outcome-based supervision or process-based supervision, the reward model is capable of generating reward signals not only for the outcome of performing the task (e.g., the final answer to the query), but also for individual reasoning steps. By using the reward model to provide reward signals to the reasoning steps, the language model is improved on performing the reasoning task, e.g., by reducing outcome errors and/or reasoning trace errors.

### BRIEF DESCRIPTION OF THE DRAWINGS

FIG. 1A shows an example training system for training a language model to perform a reasoning task.

FIG. 1B shows a reinforcement learning process performed by the training system.

FIG. 2A shows an example of using a reward model to select expert reasoning traces.

FIG. 2B shows an example of using a reward model to generate expert reasoning traces.

FIG. 3 is a flow diagram of an example process for training a language model.

FIG. 4 is a flow diagram of an example process for performing a reasoning task using a trained language model.

Like reference numbers and designations in the various drawings indicate like elements.

### DETAILED DESCRIPTION

This specification describes techniques for training a language model to perform reasoning tasks. In particular, the language model is trained to generate, in response to a query (e.g., a question), a response that includes a sequence of reasoning steps leading to a final answer (e.g., as the last reasoning step) to the query. The described techniques can be used to train the language model to perform a variety of reasoning tasks.

In one example, the trained language model can be used for diagnosing a fault in a mechanical system operating in the real-world environment. The input query can include observations about the mechanical system, e.g., from one or more sensors, and a question about the mechanical system, such as “Given the measurements from sensors A, B, and C, is the system working correctly?” The output response can provide a final answer to the question and a reasoning trace leading to the final answer.

In another example, the trained language model can be deployed as part of an educational software program that assists a user in learning or practicing one or more corresponding skills. For example, the input query can be a math word problem, and the output response includes the correct solution to the word problem and intermediate steps for reaching the correct solution. The output response can be provided to a student as a demonstration of how to solve the math problem, or be used as a grading tool to provide feedback on the student's practice.

In another example, the trained language model can be used for natural language control of a task in a real-world environment. The input query can relate to the task, e.g. it may include a request to perform the task. The output response may be used to control e.g. a mechanical system (which may be referred to as a mechanical agent), or a computer system for performing the task. As one example, the input query can include a high-level question, e.g. from a human, to perform a task, e.g., “What is the most cost-effective way to fabricate this component with our current equipment?” The output response includes a final answer specifying a planned procedure, and the reasoning steps for determining the planned procedure. The output response can be used to control one or more mechanical agents, e.g., robotic arms, to perform the planned procedure. In some other examples, the reasoning trace in the output response can be used to provide a human-interpretable explanation that can be used, e.g., by a user to 1) determine whether to perform the actions specified in the final answer in the output response or 2) later accessed when certain criteria are satisfied to evaluate the performance of the language model or to diagnose causes for errors occurring as a consequence of performing the actions specified in the responses generated by the language model. In some implementations, the output response can specify actions or routes to be taken in the real-world environment by a human user to perform the task, and the system can provide the output response to the human user, e.g., via a display or an audio output device, to guide the user to perform the task in the real-world environment.

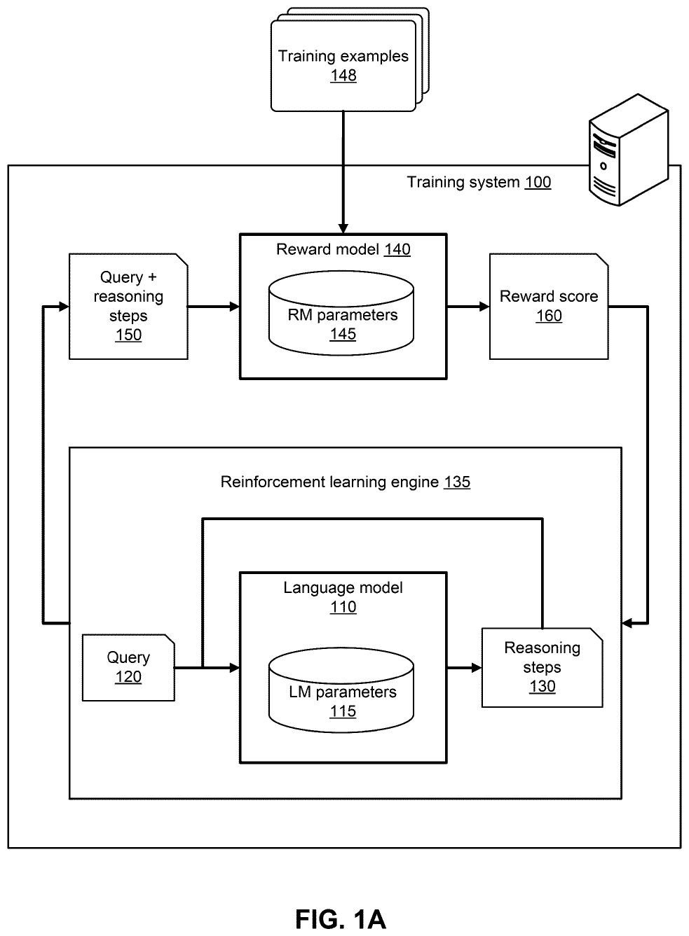

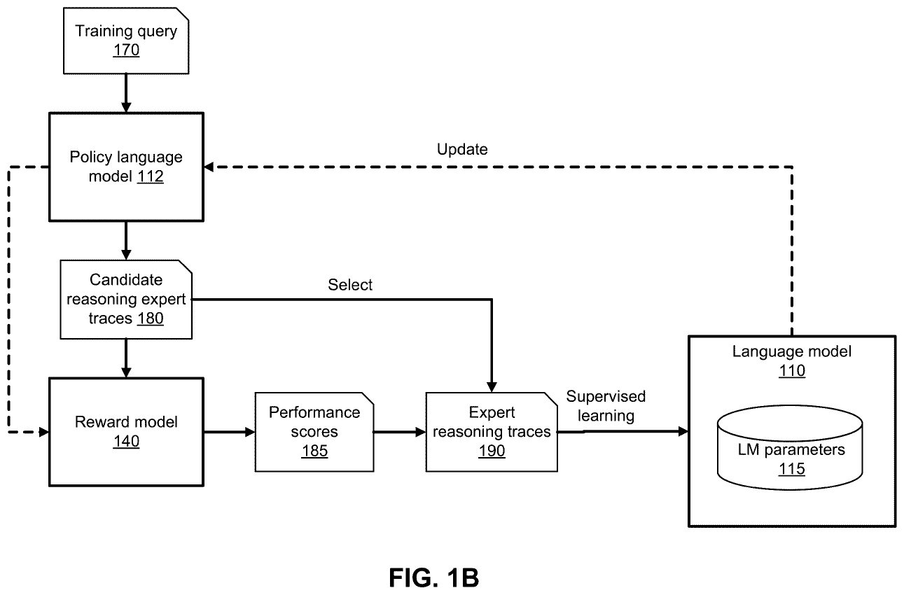

FIG. 1A shows an example training system 100 for training a language model 110 to perform a reasoning task. The training system 100 is an example of a system implemented as computer programs on one or more computers in one or more locations, in which the systems, components, and techniques described below can be implemented.

In general, the language model 110 is trained to generate, in response to a query 120, a response 130 that includes a sequence of reasoning steps leading to a final answer to the query.

Referring back to FIG. 1A, the language model 110 has a set of language model parameters 115. In some implementations, at each of a plurality of steps, the language model 110 can process an input including the query 120 to generate an output 150 that characterizes the reasoning steps 130 in a reasoning trace in response to the query 120. Each of the query 120 and the reasoning steps 130 can include a text token sequence.

The training system 100 includes a reinforcement learning engine 135 that performs reinforcement learning to update the language model parameters 115 of the language model 110 using a reward model 140. The reward model 140 is configured to process an input 150 including a query text sequence characterizing a query and one or more reasoning steps that have been generated in response to the query 120 to compute a reward score 160 indicating how successful the one or more reasoning steps are in yielding a correct final answer to the query.

The language model 110 can be a neural network that is configured to process an input to generate an output that includes a probability distribution over a set of text tokens in a vocabulary of text tokens, with the probability for each token representing the likelihood that the text token immediately follows the input.

The vocabulary of text tokens can include any appropriate tokens that appear in natural language text, e.g., ASCII characters, words, word pieces, or differently distributed n-grams. For example, the vocabulary of text tokens can be fixed or can have been generated by applying an appropriate tokenizer, e.g., a byte pair encoding tokenizer or the SentencePiece tokenizer to a corpus of text.

For example, the language model 110 can be an auto-regressive neural network. The language model 110 is referred to as an auto-regressive neural network because the neural network auto-regressively generates an output sequence of tokens by generating each particular token in the output sequence conditioned on a current input sequence that includes any (e.g. all) tokens that precede the particular text token in the output sequence, i.e., tokens that have already been generated for any previous positions in the output sequence that precede the particular position of the particular token, and a context input that provides context for the output sequence (a “context sequence”), e.g. a text token sequence representing the query 120.

For example, the current input sequence when generating a token at any given position in the output sequence can include the context sequence and the tokens at any preceding positions that precede the given position in the output sequence. As a particular example, the current input sequence can include the context sequence followed by the tokens at any (e.g. all) preceding positions that precede the given position in the output sequence. Optionally, the context and the current output sequence can be separated by one or more predetermined tokens within the current input sequence.

More specifically, to generate a particular token at a particular position within a candidate output sequence, the neural network can process the current input sequence to generate a score distribution, e.g., a probability distribution, that assigns a respective score, e.g., a respective probability, to each text token in the vocabulary of text tokens. The neural network can then select, as the particular token, a text token from the vocabulary using the score distribution. For example, the neural network can greedily select the highest-scoring token or can sample, e.g., using nucleus sampling or another sampling technique, a token from the distribution.

As a particular example, the language model 110 can be or comprise an auto-regressive Transformer-based neural network that includes (i) a sequence comprising a plurality of attention blocks that each apply a self-attention operation and (ii) an output subnetwork that processes an output of the last attention block to generate the score distribution.

The neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millic an, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoory Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in a given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

In some implementations, prior to reinforcement learning, the language model 110 can be initialized using a base language model that has been pre-trained using unsupervised learning. That is, the language model 110 can start with the same architecture and weights as the base language model which has been trained on a corpus of text to perform one or more language modeling tasks that do not require labeled training examples. For example, the system 100 or another training system can pre-train the base language model on a masked language modeling (MLM) task for predicting a masked portion of the input text, a next sentence prediction (NSP) for predicting, given two sentences, whether the second sentence is the subsequent sentence of the first sentence, and/or an autoregressive pre-training (ARP) task for predicting, given a sequence of tokens, the next token in the sequence. As a particular example, the language model 110 can be pre-trained on a maximum-likelihood objective on a large dataset of text, e.g., text that is publicly available from the Internet or another text corpus.

In some implementations, prior to reinforcement learning and after initializing the language model 110, the system 100 can fine-tune the language model 110 using supervised finetuning (SFT) based on a set of supervised training examples. Each supervised example includes a training input token sequence and a corresponding target output token sequence. During SFT, the system 100 performs supervised learning to update the parameters of the language model 110, e.g., to maximize the log-likelihood of the language model 110 outputting the target output token sequence for the corresponding training input sequence. In some implementations, the supervised training examples include examples of input queries and corresponding target reasoning traces of the input queries. That is, the training input token sequence is the token sequence representing an input query, while the target output token sequence is the token sequence representing the target reasoning trace.

In some of these implementations, the system 100 can further perform contextual learning of the language model 110 by providing one or more prompts in the inputs to the language model 110. Each prompt can be an example of an input-output pair, where the input is an example of an input query and the output is an example of an output reasoning trace that should be generated in response to the input query.

The system 100 trains the reward model 140 (i.e., updates the parameters 145 of the reward model 140) using a set of training examples 148. Each training example 145 includes a respective query text sequence characterizing a respective sample query and a respective reference response text sequence. The reference response text sequence includes at least a reference final answer to the respective sample query.

As described above, the reward model 140 is configured to receive an input 150 including a query text sequence characterizing a query and one or more reasoning steps that have been generated in response to the query and process the input 150 to compute a reward score 160 indicating how successful the one or more reasoning steps are in yielding a correct final answer to the query. In some implementations, for each reasoning step in a reasoning trace generated in response to a query, the reward model 140 outputs a score for the reasoning step. In one particular example, the reward model 140 can be trained to generate a score for the reasoning step to indicate the likelihood of the reasoning step being ‘correct’ or ‘incorrect’.

In some implementations, the reward model 140 is trained to generate a score for each reasoning step in the reasoning trace to indicate whether the reasoning trace containing that step leads to a correct final answer. The resulting reward model, trained using this process, is called an outcome-supervised reward model (ORM) because its training is supervised by the reference final answer.

In some implementations of training the ORM, the system 100 obtains multiple candidate reasoning traces for each training example, in response to the sample query of the training example. As described below with reference to FIG. 1B, the system 100 can generate the candidate reasoning traces using a policy language model. The system 100 assigns a target score to each reasoning step in each candidate reasoning trace, based on the reference response text sequence in the training example. The target score indicates whether the reasoning step is correct or incorrect, based on whether the corresponding final answer in the candidate reasoning trace matches the reference final answer of the training example. That is, if the candidate reasoning trace yields the reference final answer, the system 100 assigns a target score indicating that the reasoning step is correct to each reasoning step in the candidate reasoning trace. Otherwise, the system 100 assigns a target score indicating that the reasoning step is incorrect to each reasoning step in the candidate reasoning trace. The system 100 then trains the reward model 140 to generate reward scores 160 for the reasoning steps in the candidate reasoning traces that match the corresponding target scores for the reasoning steps. For example, the system 100 can use a backpropagation-based supervised learning technique to train the reward model 140.

In some implementations, the reward model 140 is trained to generate a score for each particular reasoning step in the candidate reasoning trace to indicate whether the reasoning steps up to and including that step are correct. The resulting reward model, trained using this process, is called a process-supervised reward model (PRM) because its training is supervised by a process including intermediate reasoning steps of a reasoning trace.

In some implementations of training the PRM, the reference response text sequence for each training example includes a reference reasoning trace, which is a sequence of reasoning steps with the final answer as the last step. The system 100 assigns a target score to the current reasoning step based on whether the reasoning steps generated up to that point match the sequence of reasoning steps in the reference reasoning trace. That is, the target score for the current reasoning step may be determined based on comparisons (e.g. similarity score) between each of the reasoning steps that have been generated up to (and including) the current reasoning step and corresponding reasoning steps in the sequence of reasoning steps in the reference reasoning trace.

In some implementations of training the PRM, the system 100 can determine the target scores for the reasoning steps in the candidate reasoning traces using feedback from human annotators. For example, the system 100 or another system can present human annotators with (i) the sample query and the reference response text sequence of the training example and (ii) the candidate reasoning traces obtained for the training example. The system 100 can then receive inputs from the annotators identifying the first reasoning step in a candidate reasoning trace with a major mistake, if any exist. In one example, a major mistake is defined as a step where the information expressed is incorrect, or it would no longer be possible to reach the correct solution without undoing that step. After receiving the inputs from the annotators, the system 100 can assign target scores for the candidate reasoning steps using the feedback from the annotators.

In some implementations, the reward model 140 can be implemented as a language model configured to process the input sequence including the query and one or more reasoning steps, and generate the output tokens indicating the correctness for a reasoning step, e.g., as ‘correct’ or “incorrect’. The reward model 140 can further output the probability assigned to the ‘correct’ token by the language model as the reward score. In some implementations, similar to the language model 110, the reward model 140 can be (i) initialized using a base language model that has been pre-trained, (ii) finetuned using SFT, and/or (iii) subjected to contextual learning through few-shot prompting.

Once the reward model 140 has been implemented, the reinforcement learning engine 135 performs reward-model-based (RM-based) reinforcement learning to update the language model 110. During the RM-based reinforcement learning, the reinforcement learning engine 130 updates, based on reward scores predicted by the reward model 140, a policy that maps an input including (i) a query 120 and (ii) reasoning steps 130 that have been generated so far to an output characterizing the next reasoning step.

FIG. 1B shows an example of an RM-based reinforcement-learning process performed by the training system 100. In the example process described below, the system 100 uses an expert iteration approach for reinforcement learning. Examples of implementing expert iteration include those described in D. Silver, et al, “Mastering the game of go without human knowledge,” Nature, 550(7676):354-359, 2017 and T. Anthony, et al., “Thinking fast and slow with deep learning and tree search,” Advances in Neural Information Processing Systems, 30, 2017. In general, the expert iteration alternates between two operations including (i) policy improvement and (ii) distillation.

In the example shown in FIG. 1B, during policy improvement, the system 100 uses a policy language model 112 and the trained reward model 140 to perform a search procedure to produce expert reasoning traces 190. During Distillation, the system 100 uses the expert reasoning traces 190 to train the language model 110, e.g., by using supervised learning.

The policy language model 112 can be implemented using any appropriate language model. In some implementations, the policy language model 112 can be the same model as the language model 110. That is, the language model 110 (e.g., after being subjected to pre-training, SFT, and/or contextual learning using few shot prompting) can be used to generate the expert reasoning traces 190. The system 100 can perform the expert iteration for a plurality of iterations. After the language model 110 has been trained using the expert reasoning traces 190 in a particular iteration, the system 100 can use the language model 110 as the policy language model 112 to generate the expert reasoning traces 190 for the next iteration. In some implementations, the system can also use the policy language model 112 to generate the candidate reasoning traces for training the reward model 140.

To generate the expert reasoning traces 190, the system 100 receives a training query 170, and uses the policy language model 112 and the trained reward model 140 to generate the expert reasoning traces 190 in response to the training query 170.

In some implementations, the system can use the policy language model 112 to generate a plurality of candidate expert reasoning traces 180 (e.g., by random sampling) in response to the training query 170, use the trained reward model 140 to generate a performance score 185 for each candidate expert reasoning trace, and select one or more candidate expert reasoning traces having the highest performance scores as the expert reasoning traces 190.

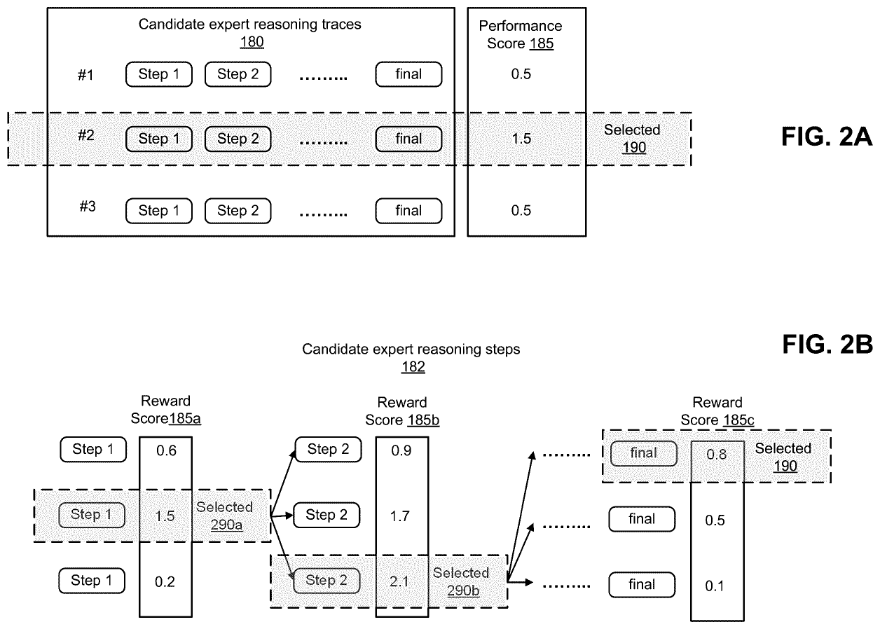

FIG. 2A shows an example of using the reward model 140 to select expert reasoning traces. The system can determine the performance score 185 for a candidate expert reasoning trace based on the reward scores generated by the reward model for each reasoning step in the candidate expert reasoning trace, for example, by summing the reward scores of the corresponding reasoning steps in the candidate expert reasoning trace. The system selects the candidate expert reasoning trace having the highest performance score as the expert reasoning trace 190. In this case, the system can use a reward model 140 that has been trained using outcome-supervised training, so the reward model (outcome-supervised reward model, ORM) is configured to generate a reward score for each reasoning step to indicate whether the reasoning step may have been in a reasoning trace that leads to a correct final answer. A policy that maximizes the ORM score at each step in general maximizes the RM-estimated probability at each step of eventually reaching the correct final answer.

FIG. 2B shows an example of using the policy language model 112 and the reward model 140 to generate the expert reasoning traces 190. In this case, after one or more reasoning steps having been generated for the expert reasoning trace, the system uses the policy language model 112 to generate a plurality of candidate next reasoning steps 182. The system uses the trained reward model to generate a reward score (e.g., 185a, 185b, or 185c) for each of the candidate next reasoning steps. The system selects the candidate next reasoning step with the highest reward score as the next step for the expert reasoning trace, and repeats the process until the next step matches a final answer indicator (e.g. until the next reasoning step comprises text corresponding to the final answer) or a maximum number of steps have been reached. In this case, the system can use a reward model 140 that has been trained using process-supervised training, so the reward model (process-supervised reward model, PRM) is configured to generate a reward score for a current reasoning step to indicate whether the reasoning steps up to the current reasoning steps are correct. A policy that maximizes the PRM score, in general, selects each step to maximize the RM-estimated probability of the steps so far being correct. If the steps so far are correct, this typically means such a policy minimizes the probability of introducing a mistake in the current step.

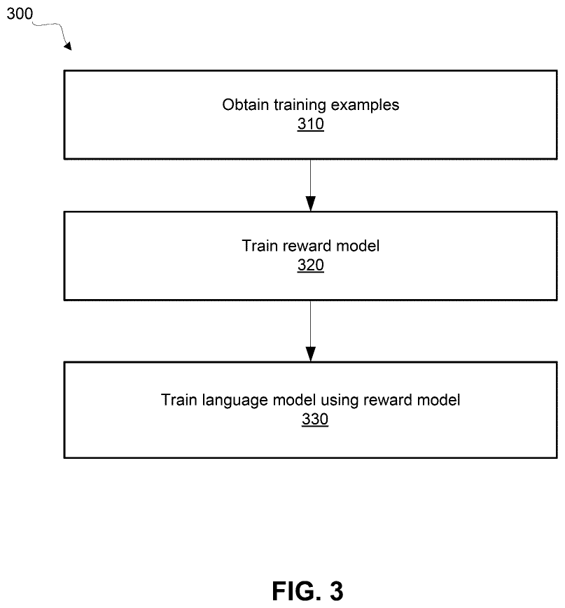

FIG. 3 is a flow diagram of an example process 300 for training a language model for performing reasoning tasks. For convenience, the process 300 will be described as being performed by a system of one or more computers located in one or more locations. For example, a training system, e.g., the training system 100 depicted in FIG. 1, appropriately programmed in accordance with this specification, can perform the process 300.

At 310, the system obtains a plurality of training examples. Each training example includes a respective sample query text sequence characterizing a respective sample query and a respective reference response text sequence that includes a reference final answer to the respective sample query. The system can obtain the training examples from one or more of a variety of data sources, such as from databases or labeled datasets. As an illustrative example, the publicly available GSM8K dataset includes math word problems and natural language solutions to the word math problems.

At 320, the system trains a reward model on the plurality of training examples. The reward model is configured to receive an input including a query text sequence characterizing a query and one or more reasoning steps that have been generated in response to the query and process the input to compute a reward score indicating how successful the one or more reasoning steps are in yielding a correct final answer to the query.

As described above, the system can train the reward model based on candidate reasoning traces and target scores assigned to reasoning steps in the candidate reasoning traces. The target scores can be assigned based on (i) outcome-supervised training, where the training of the reward model is supervised by the reference final answer of the training example, or (ii) process-supervised training, where the training of the reward model is supervised by a process represented by a reasoning trace.

At 330, the system trains the language model using the trained reward model. As described above, the system performs RM-based reinforcement learning to update the parameters of the language model. That is, during reinforcement learning, the system uses the reward model to generate the reward. As described above, the reward model can be implemented as a language model configured to process the input sequence including the query and one or more reasoning steps, and generate the output tokens indicating the correctness for a reasoning step, e.g., as ‘correct’ or “incorrect’. The reward model is used to provide reward signals to individual reasoning steps during reinforcement learning. This contrasts with conventional techniques where the language model is only rewarded based on the correctness of the final answer during reinforcement learning. As will be discussed with references to FIGS. 5A-6, by using the reward model to provide reward signals to the reasoning steps, the language model is improved on performing the reasoning task, e.g., by reducing outcome errors and/or reasoning trace errors.

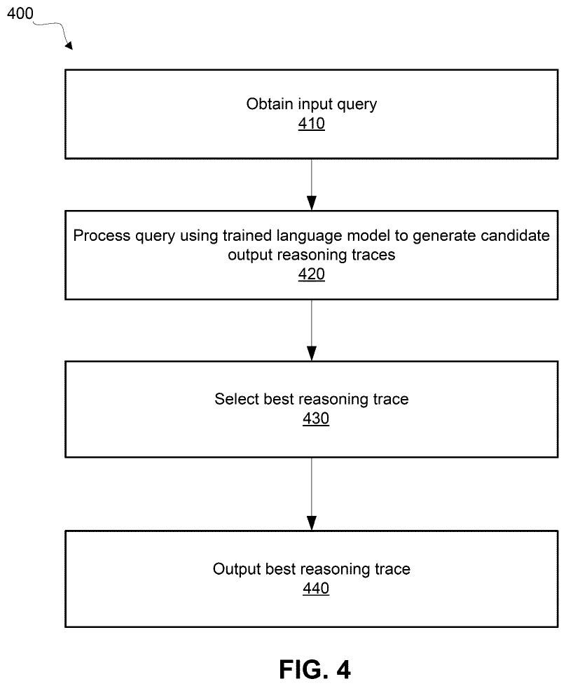

FIG. 4 is a flow diagram of an example process 400 for performing a reasoning task using a language model that has been trained using processes described with reference to FIGS. 1-3. For convenience, the process 400 will be described as being performed by a system of one or more computers located in one or more locations.

At 410, the system receives an input query. The input query can be represented by a text token sequence.

At 420, the system processes the input query using the trained language model to generate a plurality of candidate output reasoning traces in response to the input query. Each candidate output reasoning trace is a text token sequence that represents a sequence of reasoning steps where the last reasoning step in the reasoning trace is or comprises a final answer generated in response to the input query. As described with reference to FIG. 1, because the language model is auto-regressive and is configured to process the current input sequence to generate a probability distribution of tokens in the vocabulary for the next token in the output, the system can use the same model to generate multiple different candidate output sequences in response to the same query by sampling from the probability distribution.

At 430, the system selects a best reasoning trace from the candidate output reasoning traces using a ranking strategy. In some implementations, the system can use the reward model that has been trained using training processes described with reference to FIG. 1 to select the best reasoning trace to output. Specifically, the system can use the trained reward model to compute a performance score for each candidate output reasoning trace. In some implementations, the system can select the candidate output reasoning trace having the highest performance score as the output reasoning trace. In some other implementations, the system can weight the final answer in each candidate output reasoning trace with the corresponding performance score, and identify the final answer having the largest total weight as the ‘correct’ final answer. That is, a total weight for each final answer may be determined by summing the performance scores for each output reasoning trace that has that final answer and the “correct” final answer is then identified as the final answer having the largest total weight. The system can then select among candidate output reasoning traces leading to the identified ‘correct’ final answer based on the performance scores.

At 440, the system outputs the best reasoning trace. In some implementations, to guarantee the quality of the generated response, the system can choose not to provide an output response when the performance score estimated by the reward model for the best reasoning trace is below a threshold. That is, before outputting the best reasoning trace as the output response, the system can determine if the score estimated by the reward model for the best reasoning trace is below a threshold, and only output the best reasoning trace as the output response in response to determining that the score is not below the threshold.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, .e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method of training a language model for performing a reasoning task, the method comprising:
obtaining a plurality of training examples, wherein each training example includes a respective sample query text sequence characterizing a respective sample query and a respective reference response text sequence that comprises a reference final answer to the respective sample query;
training a reward model on the plurality of training examples, wherein the reward model is configured to receive an input including a query text sequence characterizing a query and one or more reasoning steps that have been generated in response to the query and process the input to compute a reward score indicating how successful the one or more reasoning steps are in yielding a correct final answer to the query; and
training the language model using the trained reward model.

2. The method of claim 1, wherein training the language model using the trained reward model comprises:
receiving a training query;
using a policy language model and the trained reward model to generate one or more expert reasoning traces in response to the training query, each respective expert reasoning trace including a respective plurality of reasoning steps; and
using the one or more expert reasoning traces to train the language model.

3. The method of claim 1, wherein training the reward model on the plurality of training examples comprises, for each of one or more of the training examples:
obtaining a plurality of candidate reasoning traces in response to the sample query of the training example, wherein each candidate reasoning trace includes one or more reasoning steps;
assigning a target score for each reasoning step in each candidate reasoning trace based on the reference response text sequence in the training example, wherein the target score indicates whether the reasoning step is correct or incorrect; and
training the reward model to generate reward scores for the reasoning steps in the candidate reasoning traces that match the corresponding target scores for the reasoning steps.

4. The method of claim 3, wherein assigning the target score for each reasoning step in the candidate reasoning trace comprises:
determining whether the candidate reasoning trace yields the reference final answer in the training example;
in response to determining that the candidate reasoning trace yields the reference final answer in the training example, assigning to each reasoning step in the candidate reasoning trace a target score indicating that the reasoning step is correct; and
in response to determining that the candidate reasoning trace does not yield the final answer in the training example, assigning to each reasoning step in the candidate reasoning trace a target score indicating that the reasoning step is incorrect.

5. The method of claim 3, wherein for each training example, the reference response text sequence includes a reference reasoning trace including a sequence of reasoning steps that include the final answer as the last reasoning step, and wherein assigning the target score to each reasoning step in the candidate reasoning trace comprises:
assigning the target score for a current reasoning step based on whether the reasoning steps that have been generated up to the current reasoning step matches the sequence of reasoning steps in the reference reasoning trace.

6. The method of claim 3, further comprising:
receiving a training query;
using a policy language model and the trained reward model to generate one or more expert reasoning traces in response to the training query, each respective expert reasoning trace including a respective plurality of reasoning steps; and
using the one or more expert reasoning traces to train the language model;
wherein the policy language model is configured to receive an input including a query text sequence characterizing a query and one or more reasoning steps that have been generated in response to the query, and process the input to generate a next reasoning step.

7. The method of claim 6, wherein generating the expert traces comprises:
using the policy language model to generate a plurality of candidate expert reasoning traces in response to the training query;
using the reward model to generate a performance score for each of the candidate expert reasoning traces based on respective reward scores generated for each of one or more of the reasoning steps in the candidate expert reasoning trace; and
selecting one or more candidate expert reasoning traces having the highest performance scores as the expert reasoning traces.

8. The method of claim 6, wherein generating one of the expert trace traces comprises:
after one or more reasoning steps having been generated for the expert reasoning trace, using the policy language model to generate a plurality of candidate next reasoning steps;
using the reward model to generate a reward score for each of the candidate next reasoning steps;
selecting the candidate next reasoning step with the highest reward score as the next step for the expert reasoning trace; and
repeating the using and selecting steps until the next step matches a final answer indicator or a maximum number of steps have been reached.

9. The method of claim 1, further comprising:
obtaining a base language model.

10. The method of claim 8, further comprising:
updating the base language model to generate the policy language model.

11. The method of claim 10, wherein updating the base language model to generate the policy model comprises:
performing supervised fine-tuning of the base language model on supervised training examples.

12. The method of claim 9, wherein training the language model comprises:
initializing the language model based on the base language model.

13. The method of claim 9, wherein training the reward model comprises:
initializing the reward model based on the base language model.

14. The method claim 1, further comprising:
updating the reward model using the trained language model.

15. The method of claim 1, further comprising using the trained language model to generate an output response to an input query relating to a real-world environment, the output response providing information about the real-world environment or specifying actions or routes to be taken in the real-world environment.

16. The method of claim 15, wherein the input query relates to a task in the real-world environment, the method further comprising using the generated output response to control one or more mechanical agents acting in the real-world environment or a computer system to perform the task.

17. The method of claim 15, wherein the input query relates to a task in the real-world environment, and the output response specifies actions or routes to be taken in the real-world environment, the method further comprising providing the output response to a user for guiding the user to perform the task in the real-world environment.

18. (canceled)

19. A computer-implemented method for performing a reasoning task using a language model, the method comprising:
obtaining an input text sequence characterizing an input query;
obtaining a reward model that has been trained on a plurality of training examples, wherein each training example includes a respective sample query text sequence characterizing a sample query and a respective reference response text sequence, wherein the reference response text sequence includes at least a reference final answer to the sample query, and wherein the reward model is configured to process an input including a query text sequence characterizing a query and one or more reasoning steps that have been generated in response to the query, to compute a reward score indicating how successful the one or more reasoning steps are for yielding a correct final answer to the query;
using the language model to generate a plurality of candidate reasoning traces as responses to the input query, each candidate reasoning trace including a respective plurality of candidate reasoning steps that include a candidate final answer;
selecting, based on one or more reward scores computed by the trained reward model, a best reasoning trace from the plurality of candidate reasoning traces; and
outputting the best reasoning trace as an output response to the input query.

20. The method of claim 19, wherein selecting, based on one or more scores computed by the trained reward model, a best reasoning trace from the plurality of candidate reasoning traces comprises:
using the reward model to generate a respective weight for each of the plurality of candidate reasoning traces, wherein the respective weight measures an estimated correctness probability of the respective candidate reasoning trace;
selecting an optimal final answer as the candidate final answer that has the largest total weight; and
among the candidate reasoning traces that yield the optimal final answer, selecting the candidate reasoning trace having the highest weight estimated by the reward model as the best reasoning trace.

21. (canceled)

22. (canceled)

23. (canceled)

24. (canceled)

25. (canceled)

26. (canceled)

27. (canceled)

28. (canceled)

29. A system comprising:
one or more computers; and
one or more storage devices storing instructions that when executed by the one or more computers, cause the one or more computers to perform the operations comprising:
obtaining a plurality of training examples, wherein each training example includes a respective sample query text sequence characterizing a respective sample query and a respective reference response text sequence that comprises a reference final answer to the respective sample query;
training a reward model on the plurality of training examples, wherein the reward model is configured to receive an input including a query text sequence characterizing a query and one or more reasoning steps that have been generated in response to the query and process the input to compute a reward score indicating how successful the one or more reasoning steps are in yielding a correct final answer to the query; and
training the language model using the trained reward model.

30. (canceled)
